(19) United States
(12) Patent Application Publication
(10) Pub. No.: US 2016/0191658 A1
(43) Pub. Date: Jun. 30, 2016

(54) EFFICIENT DELIVERY OF WEBPAGES

(71) Applicant: Instart Logic, Inc., (US)

(72) Inventors: Hariharan Kolam, Palo Alto, CA (US); Raghu Batta Venkat, Palo Alto, CA (US); Manav Ratan Mital, San Carlos, CA (US); Rajeev Kumar, Bangalore (IN); Abhishek Marwah, Belmont, CA (US); Brian Kennedy, Mountain View, CA (US)

(21) Appl. No.: 13/836,512

(22) Filed: Mar. 15, 2013

(51) Int. Cl. G06Q 10/08

(52) U.S. Cl. CPC H04L 67/32

(57) ABSTRACT

A method of delivering a webpage including dynamic content is disclosed. A request for the webpage directed to a third-party site is received. Likely components corresponding to the webpage is determined with a processor based at least in part on previous responses to similar requests. The determined likely components corresponding to the webpage are sent to a sender of the request. The webpage from the third-party site is received. The remaining components corresponding to the webpage are determined with the processor. The determined remaining components corresponding to the webpage are sent in response to the request.

### BACKGROUND OF THE INVENTION

Typically, a web server needs to generate a webpage by integrating static and dynamic content. The wait time experienced by an end-user of a browsing session may vary from a few hundred milliseconds to a few seconds. Therefore, improved techniques for delivering information corresponding to a webpage would be desirable.

### BRIEF DESCRIPTION OF THE DRAWINGS

Various embodiments of the invention are disclosed in the following detailed description and the accompanying drawings.

FIG. 1 is a block diagram illustrating an embodiment of a communication 100 between a web browser and a web server.

FIG. 2 is a diagram illustrating an embodiment of a webpage described by HTML.

FIG. 3 is a block diagram illustrating an embodiment of a communication 300 between a web browser, a proxy server, and a web server.

FIG. 4 is a flow diagram illustrating an embodiment of a process 400 for delivering a webpage with dynamic content.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

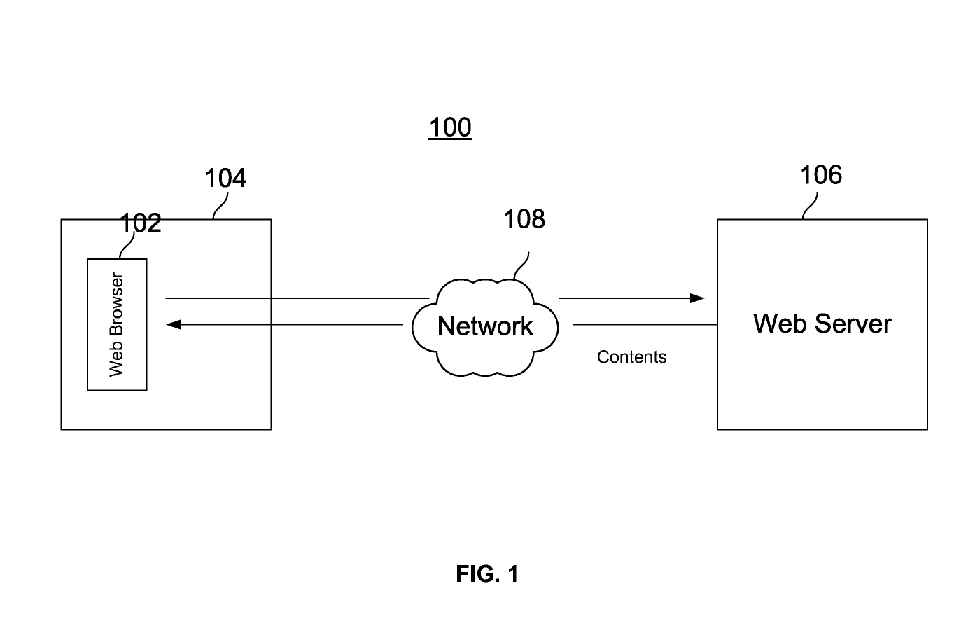

FIG. 1 is a block diagram illustrating an embodiment of a communication 100 between a web browser and a web server. As shown in FIG. 1, a web browser 102 running on a device 104 is connected to a web server 106 through a network 108. Network 108 may be a combination of public or private networks, including intranets, LANs, WANs, and the Internet. Device 104 may be a mobile phone, a personal digital assistant (PDA), a tablet personal computer, a desktop computer, and the like. Communication 100 is initiated when web browser 102 accesses a webpage. The webpage may be described by different markup languages, including Hypertext Markup Language (HTML), Extensible Markup Language (XML), and the like. The webpage may also be described by different scripting languages, including JavaScript Object Notation (JSON), and the like. HTML is used hereinafter as an example of the various languages for describing webpages. Note that the examples of HTML are selected for illustration purposes only; accordingly, the present application is not limited to these specific examples only.

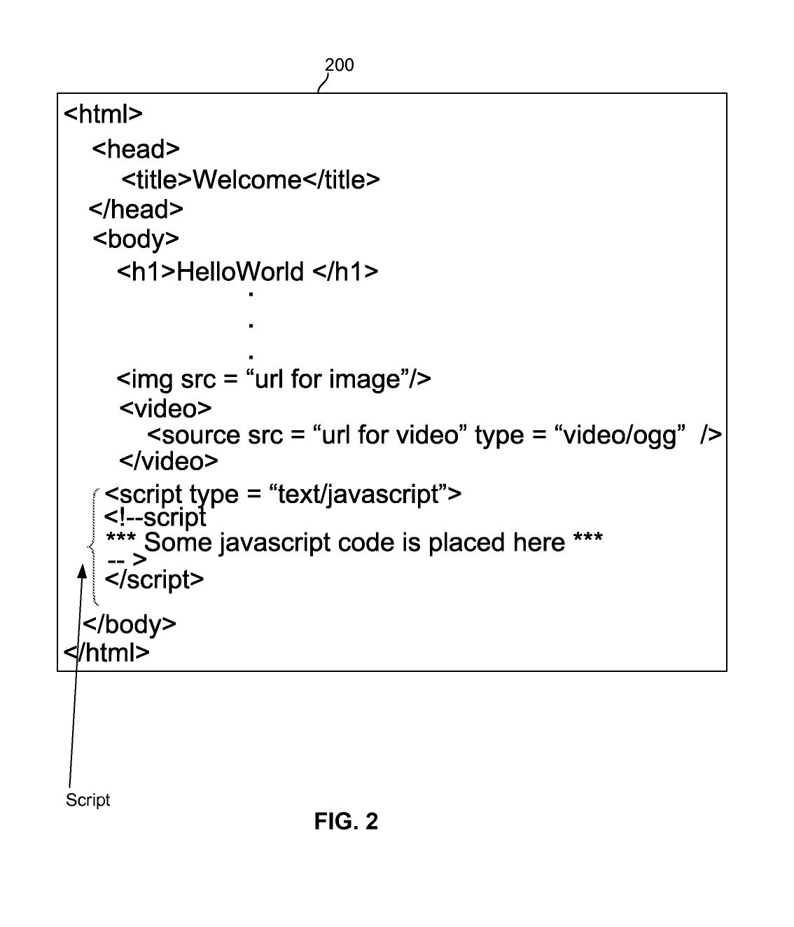

FIG. 2 is a diagram illustrating an embodiment of a webpage described by HTML. To display the webpage, web browser 102 in FIG. 1 sends a Hypertext Transfer Protocol (HTTP) request message to web server 106 requesting for the HTML webpage. After web server 106 locates or generates the requested HTML webpage, web server 106 returns the requested HTML webpage in an HTTP response message to web browser 102. Web browser 102 parses the received webpage and begins to render a portion of the webpage, e.g., a text portion, on device 104.

As shown in FIG. 2, the webpage file may include different elements. The webpage file may include one or more scripts. For example, the webpage may include a number of icons or buttons for a webpage viewer to click on. A script associated with a specific icon or button is executed on the client side only if the webpage viewer clicks on the corresponding icon or button. The webpage may include a plurality of dependent resources other than text. For example, the dependent resources may include images, videos, audio clips, uniform resource locator (URL) links, and the like. These dependent resources are resources that need to be separately transferred from web server 106 or from other servers to web browser 102. For example, as shown in FIG. 2, the list of dependent resources includes an image, which is stored at a location specified by an URL. To display the image on the webpage, web browser 102 sends a separate HTTP request message to the URL, and the image will be returned in a separate HTTP response message from the URL. Because the webpage may contain many dependent resources, and each dependent resource needs to be separately requested, received, and processed, the latency associated with obtaining these dependent resources can become significant.

The webpage file may include content that is static or dynamic. A dynamic webpage may include content that changes over time, including news, weather forecasts, market data, and the like. A dynamic webpage may also be a webpage that is generated and customized on a per-user or per-group basis. For example, when a user logs onto a social networking website (e.g., Facebook) or an online merchant website (e.g., Amazon.com), the website generates a dynamic webpage based on the user's identity.

The processing time for generating a dynamic webpage can be long, leading to long latencies and lowered responsiveness of the website perceived by the user. For example, web server 106 may be blocked by database queries to retrieve information required to generate the dynamic webpage. The processing time is dependent on the type or the amount of the information retrieved. For example, the processing time may be minimal for a simple name lookup, but long if a large block of data is fetched. Therefore, the processing time may vary from a few hundred milliseconds to several seconds. During this processing time, web browser 102 is idling and waiting for the HTTP response to its HTTP request, and web browser 102 is blocked from downloading any resources.

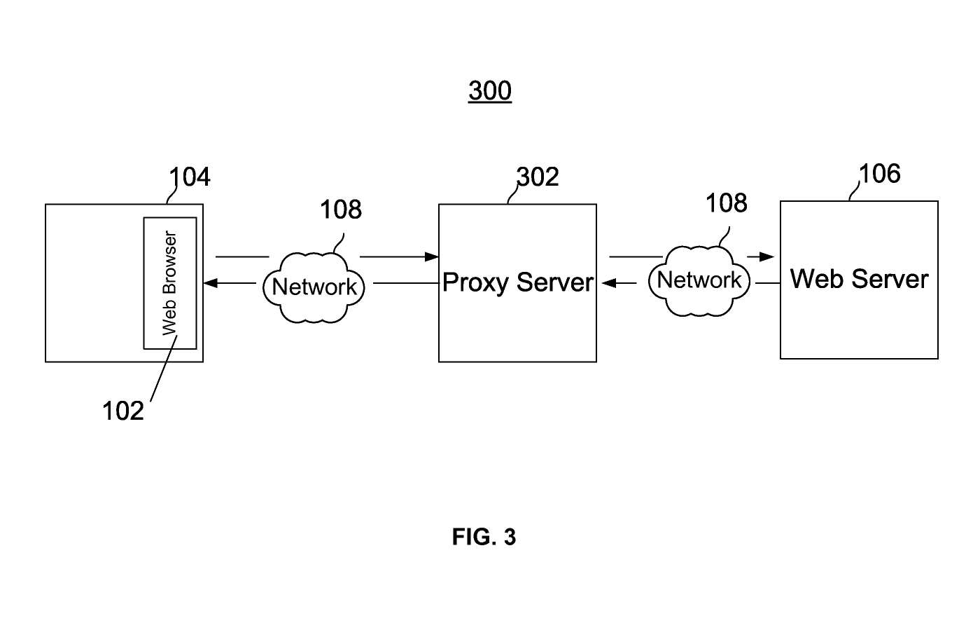

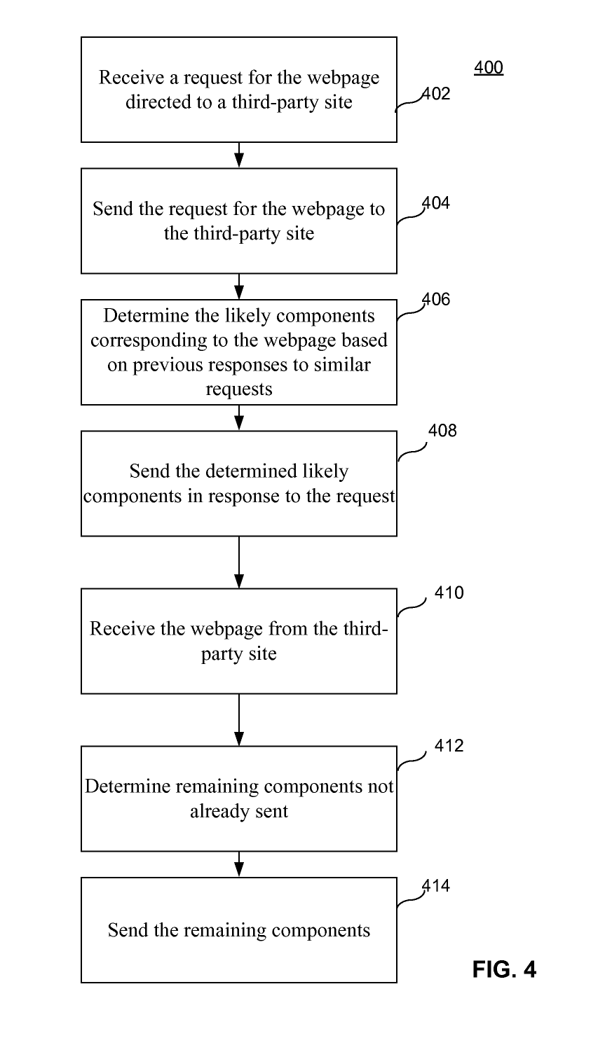

FIG. 3 is a block diagram illustrating an embodiment of a communication 300 between a web browser, a proxy server, and a web server. FIG. 4 is a flow diagram illustrating an embodiment of a process 400 for delivering a webpage with dynamic content. In some embodiments, process 400 is a process running on the proxy server in FIG. 3. Continuing with the HTML webpage illustrative example above, when web browser 102 sends an HTTP request message requesting for the HTML webpage, the HTTP request message is received by a proxy server 302 (see step 402). In some embodiments, proxy server 302 is a server that belongs to a content delivery network or content distribution network (CDN). After receiving the HTTP request message, proxy server 302 forwards the HTTP request message to web server 106 (see step 404) and waits for the HTML webpage in an HTTP response message, which is expected to be sent by web server 106 in response to the HTTP request message.

Without waiting for the arrival of the HTTP response message from web server 106, proxy server 302 may generate a temporary webpage (hereinafter referred to as the fast-delivery webpage) based on profiling information corresponding to the requested webpage (see step 406) and send the fast-delivery webpage to web browser 102 (see step 408). The fast-delivery webpage generated by proxy server 302 includes information and resources that proxy server 302 predicts web browser 102 would actually receive or need to further download had the actual webpage been received by web browser 102. Once web browser 102 begins to receive the fast-delivery webpage from proxy server 302, web browser 102 no longer needs to stay idle, but is unblocked from handling different tasks. For example, web browser 102 may begin to process any information included in the fast-delivery webpage or load some of the information onto memory, or begin to initiate any further downloading of dependent resources, including images, videos, audio clips, and the like.

Proxy server 302 continues to wait for the actual HTML webpage in an HTTP response message, which is expected to be sent by web server 106 in response to the HTTP request message. When the HTTP response message is finally generated and sent by web server 106, proxy server 302 intercepts the HTTP response message (see step 410). Proxy server 302 scans and processes the received webpage, and determines any additional or updated information that needs to be sent to web browser 102 for rendering the actual HTML webpage (see step 412). Proxy server 302 then completes the response to web browser 102 by sending the additional information to web browser 102, such that web browser 102 may complete the rendering of the actual HTML webpage (see step 414).

In one illustrative example, proxy server 302 receives a request from an end-user trying to access an online merchant's website. Proxy server 302 makes a prediction that web server 106 would send back certain information to web browser 102 based on profiling. Proxy server 302 may immediately send certain content to web browser 102, while web server 106 runs in parallel to obtain and return the remainder of the dynamic content. Proxy server 302 then relays the remaining dynamic content to web browser 102 when the content becomes available to proxy server 302.

In the above illustrative example, the original HTML webpage of the website may take web server 106 a significant period of time to generate. The original HTML webpage is thus deconstructed into two parts: the first part is sent by proxy server 302 to web browser 102 without delay, and the second part is the entire webpage minus the first part that has already been sent by proxy server 302. Because web browser 102 can begin to parse the first part of the webpage immediately on receipt without waiting for the second part to arrive, web browser 102 may take further actions, including initiating any further downloading of dependent resources, loading JavaScript onto the memory, and the like. The above described technique enables more efficient use of both bandwidth and computing resources by reducing the idling time within which bandwidth and computing resources are unutilized.

In some embodiments, the generation of the fast-delivery webpage is based at least in part on profiling information collected by proxy server 302 in relation to the requested webpage. The process of profiling may include determining the static content of the requested webpage and predicting at least some of the dynamic content of the requested webpage.

Since the static content of the requested webpage is always present in the webpage, the static content can be embedded in the fast-delivery webpage and sent to web browser 102 without further delay. Examples of static content include web templates, website or company logos, and the like.

The fast-delivery webpage may also include dynamic content. For example, proxy server 302 may analyze and profile the content and the generation of the requested webpage based on many users. The analysis and profiling may be performed on a per-user basis or per-group basis. By continuously examining the pattern for a large number of users accessing the particular webpage, proxy server 302 may predict the dynamic content that is going to be included in the actual webpage generated by web server 106, or the dependent resources that the actual webpage is going to direct web browser 102 to further download, or the data that is going to be loaded in response to the parsing or rendering of the actual webpage. Based on these predictions, proxy server 302 may generate the fast-delivery webpage. For example, the fast-delivery webpage may include the predicted dynamic content. The fast-delivery webpage may also include code (e.g., ActionScripts) to cause web browser 102 to preload certain data into memory or cache, or cause web browser 102 to download additional resources.

The fast-delivery webpage may include any elements that can be included in a typical webpage. For example, the fast-delivery webpage may include some or all of the elements as illustrated in FIG. 2, including the <head>, <title>, <body> tags, and the like.

In some embodiments, chunked transfer encoding is used to transfer updated or additional information of the requested webpage to web browser 102 once the information is returned to proxy server 302 by web server 106. Chunked transfer encoding is a data transfer mechanism in version 1.1 of HTTP wherein data is sent in a series of “chunks”. The mechanism uses the Transfer-Encoding HTTP header in place of the Content-Length header, which the protocol would otherwise require. Because the Content-Length header is not used, the sender does not need to know the length of the content before it starts transmitting a response to the receiver; senders can begin transmitting dynamically-generated content before knowing the total size of that content. The size of each chunk is sent right before the chunk itself, so that the receiver can tell when it has finished receiving data for that chunk. The data transfer is terminated by a final chunk of length zero.

For example, proxy server 302 may use chunked transfer encoding to send the static content and predicted dynamic content corresponding to the requested webpage in a series of initial “chunks” to web browser 102. The remainder of the requested webpage may be sent to web browser 102 in a series of subsequent “chunks.” When all the information corresponding to the requested webpage has been sent, the data transfer is terminated by a final chunk of length zero.

In some cases, the initial “chunks” of the fast-delivery webpage may include content that is unnecessary or incorrect. In one example, the fast-delivery webpage includes extra content that is not present in the actual webpage or the fast-delivery webpage includes code that causes web browser 102 to preload or download data that is unnecessary. In another example, the fast-delivery webpage includes content that is inconsistent with the content present in the actual webpage or the fast-delivery webpage includes codes that cause web browser 102 to preload or download incorrect data.

To handle these cases, proxy server 302 may further determine whether there are any side-effects or errors associated with the extraneous or incorrect content. Based on different criteria, proxy server 302 may make a determination as to whether further actions should be taken to undo or correct any effects caused by the extraneous content. The criteria considered may include the time and computation resources required to correct the effects, the degree of severity of the errors or side-effects, the extent to which the side-effects and errors are perceivable by the end-users, and the like. In one embodiment, if the side-effect or errors are determined to be objectionable to the end-users, web browser 102 may be directed to refresh or reload the webpage again.

In another example, the initial “chunks” of the fast-delivery webpage lack a Set-Cookie header, which is present in the actual webpage generated by web server 106. HTTP cookies provide the server with a mechanism to store and retrieve state information on the client application's system. This mechanism allows web-based applications the ability to store information about selected items, user preferences, registration information, and other information that can be retrieved later. The Set-Cookie header is sent by the server in response to an HTTP request, and used to create a cookie on the user's system. In some embodiments, proxy server 302 scans the HTTP response message from web server 106 for any Set-Cookie header. If a Set-Cookie header is found, then proxy server 302 may add code (e.g., JavaScript) in the subsequent “chunks” of the fast-delivery webpage to set the cookie.

In some cases, sending certain types of content ahead of time in the fast-delivery webpage may cause side-effects, including triggering out-of-sequence events or triggering unintended events to happen. Some webpages may include Adobe Flash file format (SWF) files, and an embedded SWF file may include additional SWF files within itself. For example, a main SWF file embedded in a webpage may load other SWF files, e.g., SWF2 file, SWF3 file, and so on. If the SWF2 file or the SWF3 file is sent ahead of the main SWF file by proxy server 302, web browser 102 will create the document object model (DOM) objects corresponding to those files. For example, if the SWF2 file includes an audio clip, web browser 102 will play the audio immediately as a result of the prefetching, causing unexpected side-effects.

In some embodiments, code may be used to selectively suppress or prevent certain effects that are caused by the content being sent in advance in the fast-delivery webpage. For example, the content sent in the fast-delivery webpage may be the audio portion of a multimedia presentation, and should not be played until the download of the entire presentation is complete. In one embodiment, the SWF files (e.g., the SWF2 and SWF3 files) that are sent in advance in a fast-delivery webpage are placed within an iframe. The <iframe> tag specifies an inline frame which is used to embed another document within the current HTML document. Attributes of the iframe may be set in such a way that some of the functions or features are disabled; for example, an attribute may be set to turn off visibility. When web browser 102 renders this iframe with visibility attribute set to OFF, the SWF files (i.e., SWF2 and SWF3 files) embedded within the iframe are merely loaded into the local cache. When the main SWF file is received by proxy server 302, proxy server 302 may send it to web browser 102. Web browser 102 then loads the main SWF, and when the main SWF file needs to load SWF2, and SWF2 needs to load SWF3, all of those dependent SWF files can be fetched from the local cache rather than from across the network. Rendering of the content of iframe can be enabled again by deleting the iframe or setting the visibility attribute to ON.

Although the foregoing embodiments have been described in some detail for purposes of clarity of understanding, the invention is not limited to the details provided. There are many alternative ways of implementing the invention. The disclosed embodiments are illustrative and not restrictive.

1. A method of delivering a webpage including dynamic content, comprising:
receiving a request for the webpage directed to a third-party site;
determining with a processor predicted components corresponding to the webpage based at least in part on previous responses to similar requests, wherein determining predicted components corresponding to the webpage comprises determining whether a component is a static component or a dynamic component, and in the event of determining that a component is a static component, determining that the static component is a predicted component;
in response to the received request, sending the determined predicted components corresponding to the webpage in a webpage file to a sender of the request prior to receiving art site;
receiving the updated version of the webpage from the third-party site;
determining with the processor remaining components corresponding to the webpage based on the received updated version of the webpage from the third-party site; and
sending the determined remaining components corresponding to the webpage.

2. The method of claim 1, further comprising sending the request to the third-party site.

3. (canceled)

4. (canceled)

5. The method of claim 1, further comprising, causing the sender of the request, upon receiving at least some of the determined predicted components corresponding to the webpage, to be unblocked from at least one task that is blocked by waiting for the webpage.

6. The method of claim 1, further comprising, causing the sender of the request, upon receiving at least some of the determined predicted components corresponding to the webpage, to begin rendering based at least in part on the determined predicted components corresponding to the webpage.

7. The method of claim 6, wherein begin rendering comprises one of the following: loading data into memory or cache, loading code into memory or cache, and downloading dependent resources, wherein the data, the code, and the dependent resources are used for rendering the webpage.

8. (canceled)

9. The method of claim 1, wherein the determined predicted components comprises dynamic content.

10. The method of claim 1, further comprising determining whether rendering the determined predicted components of the webpage causes a side-effect or an error.

11. The method of claim 10, further comprising determining whether to correct the side-effect or error.

12. The method of claim 11, further comprising correcting the side-effect by sending updates corresponding to the determined predicted components based on the webpage received from the third-party site.

13. The method of claim 1, further comprising determining that a Set-Cookie header is not included in the determined predicted components and sending a JavaScript to the sender to set a cookie based at least in part on the received webpage from the third-party site.

14. The method of claim 1, wherein the determined predicted components correspond to SWF files, and wherein the method further comprises sending the components within iframe tags and setting an attribute of the iframe to prevent a side-effect of the components being rendered in advance.

15. A system for delivering a webpage including dynamic content, comprising:
a processor configured to:
receive a request for the webpage directed to a third-party site;
determine predicted components corresponding to the webpage based at least in part on previous responses to similar requests, wherein determining predicted components corresponding to the webpage comprises determining whether a component is a static component or a dynamic component, and in the event of determining that a component is a static component, determining that the static component is a predicted component;
in response to the received request, send the determined predicted components corresponding to the webpage in a webpage file to a sender of the request prior to receiving an updated version of the webpage from the third-party site;
receive the updated version of the webpage from the third-party site;
determine remaining components corresponding to the webpage based on the received updated version of the webpage from the third-party site; and
send the determined remaining components corresponding to the webpage; and
a memory coupled to the processor and configured to provide the processor with instructions.

16. The system recited in claim 15, wherein the memory is further configured to provide the processor with instructions which when executed cause the processor to send the request to the third-party site.

17. (canceled)

18. (canceled)

19. The system recited in claim 15, wherein the memory is further configured to provide the processor with instructions which when executed cause the processor to: cause the sender of the request, upon receiving at least some of the determined predicted components corresponding to the webpage, to be unblocked from at least one task that is blocked by waiting for the webpage.

20. The system recited in claim 15, wherein the memory is further configured to provide the processor with instructions which when executed cause the processor to: cause the sender of the request, upon receiving at least some of the determined predicted components corresponding to the webpage, to begin rendering based at least in part on the determined predicted components corresponding to the webpage.

21. The system recited in claim 20, wherein begin rendering comprises one of the following: loading data into memory or cache, loading code into memory or cache, and downloading dependent resources, wherein the data, the code, and the dependent resources are used for rendering the webpage.

22. (canceled)

23. The system recited in claim 15, wherein the determined predicted components comprises dynamic content.

24. The system recited in claim 15, wherein the memory is further configured to provide the processor with instructions which when executed cause the processor to: determine whether rendering the determined predicted components of the webpage causes a side-effect or an error.

25. The system recited in claim 24, wherein the memory is further configured to provide the processor with instructions which when executed cause the processor to:
determine whether to correct the side-effect or error.

26. The system recited in claim 25, wherein the memory is further configured to provide the processor with instructions which when executed cause the processor to: correct the side-effect by sending updates corresponding to the determined predicted components based on the webpage received from the third-party site.

27. The system recited in claim 15, wherein the memory is further configured to provide the processor with instructions which when executed cause the processor to: determine that a Set-Cookie header is not included in the determined predicted components and send a JavaScript to the sender to set a cookie based at least in part on the received webpage from the third-party site.

28. The system recited in claim 15, wherein the determined predicted components correspond to SWF files, and wherein the memory is further configured to provide the processor with instructions which when executed cause the processor to: send the components within iframe tags and set an attribute of the iframe to prevent a side-effect of the components being rendered in advance.

29. A computer program product for delivering a webpage including dynamic content, the computer program product being embodied in a non-transitory computer readable storage medium and comprising computer instructions for:
receiving a request for the webpage directed to a third-party site;
determining predicted components corresponding to the webpage based at least in part on previous responses to similar requests, wherein determining predicted components corresponding to the webpage comprises determining whether a component is a static component or a dynamic component, and in the event of determining that a component is a static component, determining that the static component is a predicted component;
in response to the received request, sending the determined predicted components corresponding to the webpage in a webpage file to a sender of the request prior to receiving an updated version of the webpage from the third-party site;
receiving the updated version of the webpage from the third-party site;
determining remaining components corresponding to the webpage based on the received updated version of the webpage from the third-party site; and
sending the determined remaining components corresponding to the webpage.
